(19) United States
(12) Patent Application Publication
(10) Pub. No.: US 2006/0028477 A1
(43) Pub. Date: Feb. 9, 2006

(54) System and method for efficiently performing manual partial transfers of image data

(76) Inventors: Juraj Bystricky, Richmond (CA); Doug McFadyen, Delta (CA); Roc Carson, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/913,217

(22) Filed: Aug. 6, 2004

(51) Int. Cl. G09G 5/37; G06T 1/00; G06F 15/00

(52) U.S. Cl. 345/501; 345/562

(57) ABSTRACT

A system and method for performing manual partial transfers of image data includes a display controller with controller logic and a rectangle module. The rectangle module detects write operations to on-screen data in a video memory, and then updates a transfer rectangle to include written data from the foregoing write operations. The controller logic generates a transfer interrupt in response to a transfer trigger event in the display controller for initiating a manual partial transfer operation from the video memory to a display device. A central processing unit from a host electronic device detects the transfer interrupt and responsively coordinates the manual partial transfer operation to transfer rectangle data of the transfer rectangle from the video memory to the display device of the host electronic device.

### BACKGROUND SECTION

1. Field of Invention

This invention relates generally to electronic display controller systems, and relates more particularly to a system and method for efficiently performing manual partial transfers of image data.

2. Description of the Background Art

Implementing efficient methods for displaying electronic image data is a significant consideration for designers and manufacturers of contemporary electronic devices. However, efficiently displaying image data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced display control operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the display of electronic image data is a matter of concern for related electronic technologies. Therefore, for all the foregoing reasons, developing efficient systems for displaying electronic image data remains a significant consideration for designers, manufacturers, and users of contemporary electronic devices.

### SUMMARY

In accordance with the present invention, a system and method are disclosed for efficiently performing manual partial transfers of image data. In certain embodiments, an electronic device may be implemented to include a central-processing unit (CPU), one or more displays, and a display controller. A rectangle module of the display controller monitors on-screen data in a video memory for image-data write operations during which the CPU or other appropriate entities transfer image data into on-screen data for display.

When such image-data write operations occur, the rectangle module performs a rectangle update procedure to ensure that a current updated transfer rectangle includes all newly-updated image pixels. Therefore, whenever a manual partial transfer operation is initiated for transferring image data from the video memory to the display, only altered image data from the current updated transfer rectangle need be transferred, instead of inefficiently transferring entire frames of image data during each transfer operation.

In certain embodiments, controller logic of the display controller may generate a transfer interrupt in response to any appropriate stimulus or event. For example, a transfer timer may trigger the controller logic to generate a transfer interrupt after a pre-determined transfer interval has been exceeded, or the controller logic may detect that a total written pixel value from a write counter has exceeded a pre-determined write-operation pixel threshold.

If the controller logic generates a transfer interrupt, then the CPU of the host electronic device may responsively coordinate a manual partial transfer operation of image data corresponding to a current transfer rectangle in video memory of the display controller. In accordance with the present invention, the CPU instructs the display controller to perform the manual partial transfer operation by sending image data of the current transfer rectangle from video memory of the display controller to a display of the host electronic device

In response, display logic of the display stores the transferred image data from the current transfer rectangle into a designated local storage location in a display memory. Finally, the display may display image data from the display memory on one or more screens for viewing by a device user. For at least the foregoing reasons, the present invention therefore supports manual transfer operations to efficiently provide transfer rectangles of image data to a display of a host electronic device.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a block diagram illustrating a transfer rectangle updating procedure, in accordance with one embodiment of the present invention;

FIG. 7 is a flowchart of method steps for performing a transfer rectangle update procedure, in accordance with one embodiment of the present invention;

FIG. 8 is a flowchart of method steps for utilizing a transfer timer, in accordance with one embodiment of the present invention; and

FIG. 9 is a flowchart of method steps for performing a manual partial transfer operation, in accordance with one embodiment of the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for performing manual partial transfers of image data, and includes a display controller with controller logic and a rectangle module. The rectangle module detects write operations to on-screen data in a video memory, and then updates a transfer rectangle to include written data from the foregoing write operations. The controller logic generates a transfer interrupt in response to a transfer trigger event in the display controller for initiating a manual partial transfer operation from the video memory to a display device. A central processing unit from a host electronic device detects the transfer interrupt and responsively coordinates the manual partial transfer operation to transfer rectangle data of the transfer rectangle from the video memory to the display device of the host electronic device.

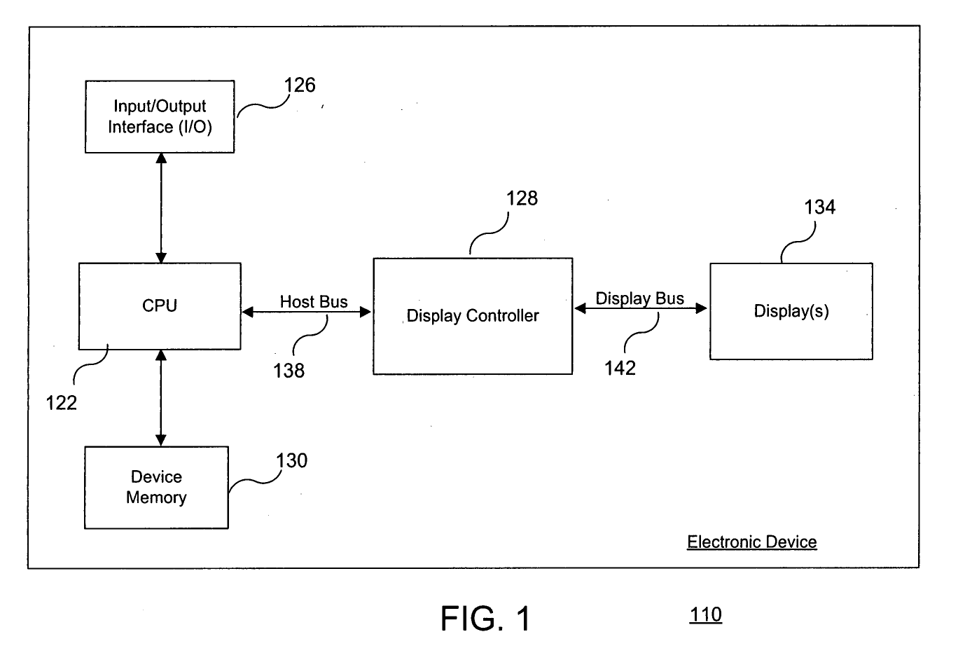

Referring now to FIG. 1, a block diagram for one embodiment of an electronic device 110 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, a device application of program instructions that are executed by CPU 122 to perform various functions and operations for electronic device 110. The particular nature and functionality of the device application typically varies depending upon factors such as the type and specific use of the corresponding electronic device 110.

In the FIG. 1 embodiment, the foregoing device application may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

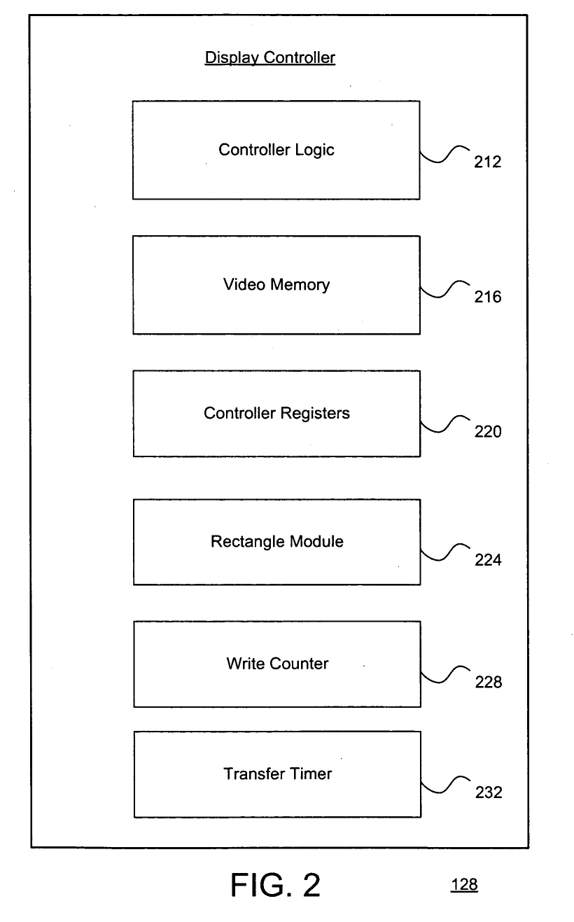

In the FIG. 1 embodiment, electronic device 110 may advantageously utilize display controller 128 for efficiently managing various operations and functionalities relating to display(s) 134. The implementation and functionality of display controller 128 is further discussed below in conjunction with FIGS. 2-4 and 6-9. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, a cellular telephone, or a computer device. Various embodiments for the operation and utilization of electronic device 110 are further discussed below in conjunction with FIGS. 2-9.

Referring now to FIG. 2, a block diagram for one embodiment of the FIG. 1 display controller 128 is shown, according to the present invention. The FIG. 2 embodiment includes, but is not limited to, controller logic 212, video memory 216, controller registers 220, a rectangle module 224, a write counter 228, and a transfer timer 232. In alternate embodiments, display controller 128 may include elements or functionalities in addition to, or instead of, certain of the elements or functionalities discussed in conjunction with the FIG. 2 embodiment.

In the FIG. 2 embodiment, display controller 128 may be implemented as an integrated circuit device that accepts image data and corresponding transfer and display information from CPU 122 (FIG. 1). Display controller 128 then provides the received image data to display 134 of electronic device 110 in an appropriate and efficient manner for displaying to a device user. In the FIG. 2 embodiment, controller logic 212 manages the overall operation of display controller 128. In certain embodiments, controller logic 212 may include, but is not limited to, an image creation module. The image creation module manages reading image data from video memory 216, and forming corresponding image pixels for display according to information from controller registers 220.

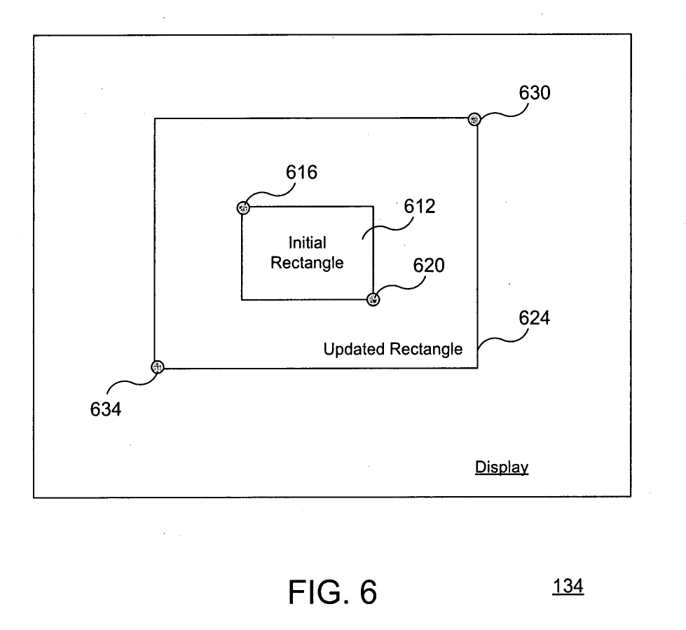

In the FIG. 2 embodiment, display controller 128 may utilize rectangle module 224 for creating and updating transfer rectangles of image pixels for performing transfer operations from display controller 128 to display 134. In accordance with the present invention, display controller 128 uses write counter 228 and transfer timer 232 to trigger partial transfer operations for transferring a transfer rectangle from video memory 216 to display 134 (FIG. 1). Certain embodiments for the implementation and utilization of rectangle module 224, write counter 228, and transfer timer 232 are further discussed below in conjunction with FIGS. 6-9.

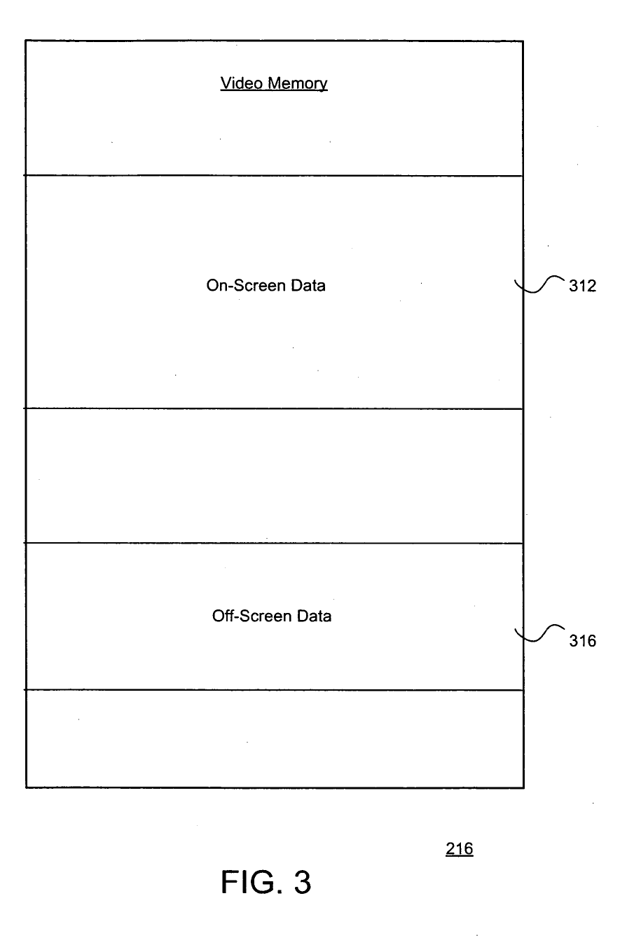

Referring now to FIG. 3, a block diagram for one embodiment of the FIG. 2 video memory 216 is shown, in accordance with the present invention. In the FIG. 3 embodiment, video memory 216 includes, but is not limited to, on-screen data 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, on-screen data 312 and off-screen data 316 are each shown as single contiguous memory blocks in video memory 216. However, in various other embodiments, different components of on-screen data 312 and/or off-screen data 316 may readily be stored as multiple non-contiguous memory blocks within video memory 216.

In the FIG. 3 embodiment, CPU 122 (FIG. 1) writes image data into on-screen data 312 for transfer by display controller 128 to display 134 of electronic device 110 for viewing by a device user. In the FIG. 3 embodiment, on-screen data 312 includes any appropriate type of information for display upon a screen of display 134 (FIG. 1). For example, on-screen data 312 may include main image data corresponding to a main window area on display 134. In addition, on-screen data 312 may include picture-in-picture (PIP) image data corresponding to one or more picture-in-picture window areas that are positioned within the foregoing main window area on display 134.

In the FIG. 3 embodiment, off-screen data 316 may include any appropriate type of information or data that is not displayed upon display 134 of electronic device 110. For example, off-screen data 316 may be utilized to support various types of double buffering schemes for display controller 128, or may also be utilized to cache certain fonts or other objects for use by display controller 128. The utilization of video memory 216 is further discussed below in conjunction with FIGS. 6-9.

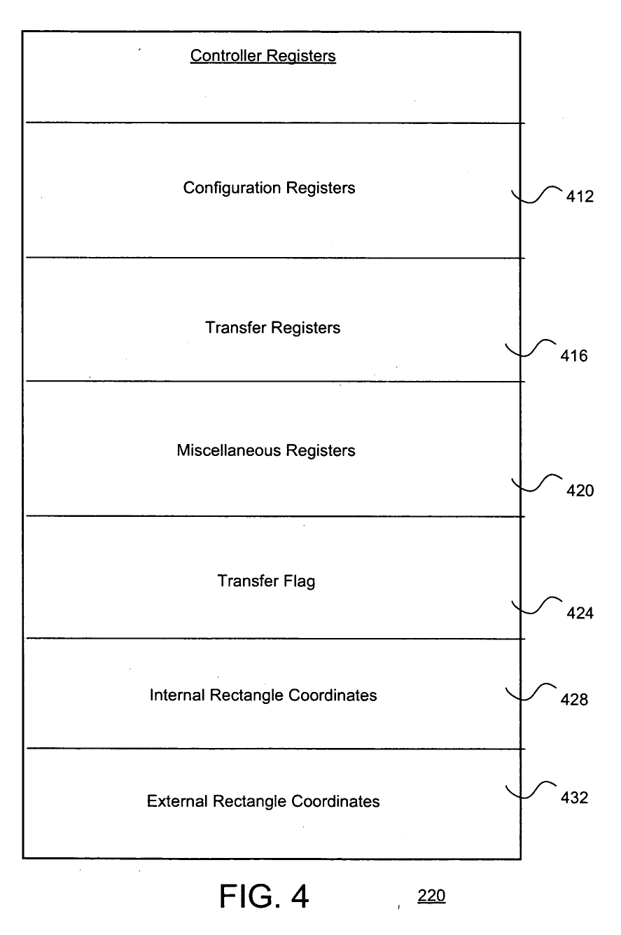

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, a transfer flag 424, internal rectangle coordinates 428, and external rectangle coordinates 432. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may advantageously write information into controller registers 220 to specify various types of operational parameters and other relevant information for use by controller logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110.

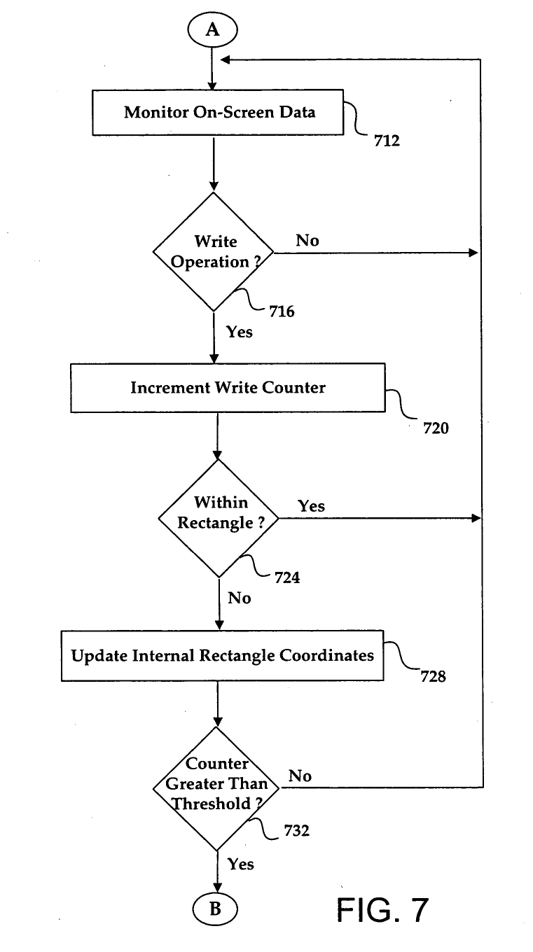

In the FIG. 4 embodiment, controller registers 220 may utilize miscellaneous registers 420 for effectively storing any desired type of information or data for use by display controller 128. In the FIG. 4 embodiment, controller logic 212, write counter 228, transfer timer 232 (FIG. 2), or other appropriate entity may set a transfer flag 424 to indicate that certain conditions for triggering a partial transfer of image data to display 134 have been met. In response, a corresponding partial transfer procedure may be initiated by copying internal rectangle coordinates 428 to external rectangle coordinates 432 for utilization by CPU 122 (FIG. 1) in coordinating the foregoing partial transfer, as discussed below in conjunction with FIGS. 7-9.

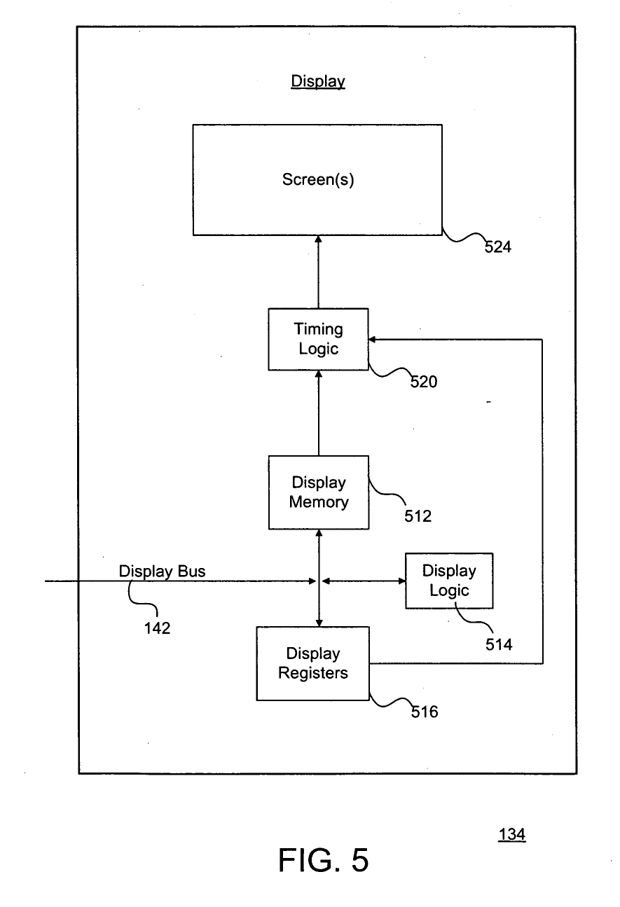

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, CPU 122 (FIG. 1) coordinates a manual partial transfer configuration procedure in which display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110. Various techniques for efficiently transferring image data to display 134 are further discussed below in conjunction with FIGS. 6 through 9.

Referring now to FIG. 6, a block diagram illustrating a transfer rectangle updating procedure is shown, in accordance with one embodiment of the present invention. The FIG. 6 embodiment is provided for purposes of illustration, and in alternate embodiments, the present invention may update transfer rectangles using procedures that include elements and functionalities in addition to, or instead of, certain of the elements and functionalities discussed in conjunction with the FIG. 6 embodiment.

In the FIG. 6 embodiment, a rectangle module 224 (FIG. 2) monitors on-screen data 312 in video memory 216 (FIG. 3) for image-data write operations during which CPU 122 or other appropriate entities transfer image data into on-screen data 312. Whenever such image-data write operations occur, rectangle module 224 performs a rectangle update procedure to ensure that a current updated transfer rectangle includes all pixels corresponding to the written image data. Therefore, whenever a transfer operation is initiated by display controller 128 for transferring image data from video memory 216 to display 134, only image data from the current updated transfer rectangle need be transferred, instead of inefficiently transferring an entire frame of image data during each transfer operation.

The utilization of the foregoing transfer rectangles to perform transfer operations to display 134 thus conserves substantial system resources by reducing the amount of data involved. Furthermore, a significant reduction in operating power consumption results because only changed pixels in on-screen data 312 need to be refreshed instead of repeatedly refreshing entire frames of pixels on display 134.

The size and location of a particular transfer rectangle is typically defined by utilizing the following notation:
[(x₁, y₁), (x₂, y₂)]
where (x₁, y₁) are the pixel coordinates of the top left pixel from the corresponding transfer rectangle, and where (x₂, y₂) are the bottom right coordinates of that same transfer rectangle. Each of the pixel coordinates of a transfer rectangle maps to a corresponding location in on-screen data 312 of video memory 216 (FIG. 3).

In the FIG. 6 example, rectangle module 224 has initially formed an initial rectangle 612 after pixel 616 and pixel 620 were written into on-screen data 312 to replace the previously existing image data at those locations. Subsequently, after rectangle module 224 detects that pixel 630 and pixel 634 have been written into on-screen data 312, then rectangle module 224 advantageously creates an updated rectangle 624 to include the newly added image data.

Therefore, in certain embodiments, if a transfer rectangle is defined by the expression [(x₁, y₁), (x₂, y₂)], and if rectangle module 224 detects that a new pixel (X,Y) has been written into on-screen data 312, then rectangle module 224 may perform four tests for potentially updating the transfer rectangle. Rectangle module 224 determines whether “X” is less than “x₁”, and if so, then updates “x₁” to equal “X”. Rectangle module 224 also determines whether “X” is greater than “x₂”, and if so, then updates “x₂” to equal “X”. Rectangle module 224 further determines whether “Y” is less than “y₁”, and if so, then updates “y₁” to equal “Y”. Finally, rectangle module 224 determines whether “Y” is greater than “y₂”, and if so, then updates “y₂” to equal “Y”. The utilization of transfer rectangles for automatically performing partial transfer operations are further discussed below in conjunction with FIG. 7.

Referring now to FIG. 7, a flowchart of method steps for performing a transfer rectangle update procedure is shown, in accordance with one embodiment of the present invention. The flowcharts shown in FIGS. 7-9 together describe one embodiment for effectively utilizing the present invention. The FIG. 7 flowchart is presented for purposes of illustration, and in alternate embodiments, the present invention may utilize steps and sequences in addition to, or instead of, certain of the steps and sequences discussed in conjunction with the FIG. 7 embodiment.

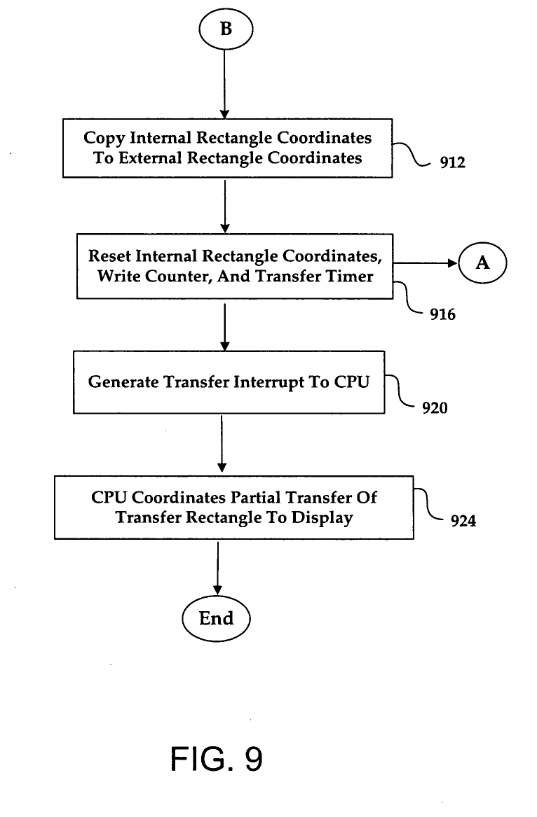

In the FIG. 7 embodiment, step 712 occurs at letter “A” which follows step 916 of FIG. 9. In step 712, rectangle module 224 initially monitors on-screen data 312. In step 716, rectangle module 224 determines whether a write operation to on-screen data 312 has occurred. If a write operation to on-screen data 312 has occurred, then in step 720, controller logic 212 increments write counter 228 by utilizing any effective means.

In step 724, rectangle module 224 determines whether the foregoing write operation to on-screen data 312 is within the boundaries of a current transfer rectangle defined by internal rectangle coordinates 428 in controller registers 220. If the write operation of step 716 is outside the boundaries of the current transfer rectangle defined by internal rectangle coordinates 428, then in step 728, rectangle module 224 updates the internal rectangle coordinates 428 in controller registers 220 to represent an updated transfer rectangle that includes any pixels that were changed in on-screen data 312 during the foregoing write operation.

In step 732, controller logic 212 determines whether the current counter value of write counter 228 is greater than a pre-determined transfer threshold value. If the current counter value of write counter 228 is not greater than the pre-determined transfer threshold value, then the FIG. 7 process returns to step 712, and repeats the foregoing steps of the FIG. 7 embodiment. However, in step 732, if the current counter value of write counter 228 is greater than the pre-determined transfer threshold value, then the FIG. 7 process advances through letter “B” to step 912 of FIG. 9.

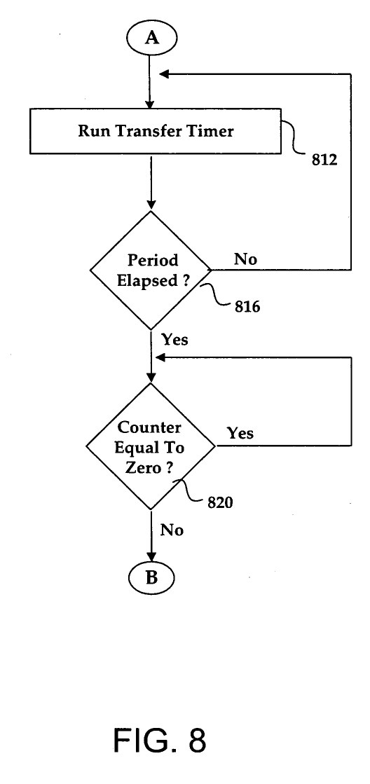

Referring now to FIG. 8, a flowchart of method steps for utilizing a transfer timer is shown, in accordance with one embodiment of the present invention. The flowcharts shown in FIGS. 7-9 together describe one embodiment for effectively utilizing the present invention. The FIG. 8 flowchart is presented for purposes of illustration, and in alternate embodiments, the present invention may utilize steps and sequences in addition to, or instead of, certain of the steps and sequences discussed in conjunction with the FIG. 8 embodiment.

In the FIG. 8 embodiment, step 812 occurs at letter “A” which follows step 916 of FIG. 9. In the FIG. 8 embodiment, in step 812, display controller 128 runs transfer timer 232 to measure a pre-determined transfer period after which a transfer operation may be triggered if at least one write operation to on-screen data 312 has occurred. In step 816, controller logic 212 determines whether the foregoing pre-determined transfer period has elapsed by evaluating a current timer value from transfer timer 232. If the pre-determined transfer period has elapsed, then in step 820, controller logic 212 determines whether a current counter value from write counter 228 is equal to zero. If the current counter value is not equal to zero, then the FIG. 8 process advances through letter “B” to step 912 of FIG. 9.

Referring now to FIG. 9, a flowchart of method steps for performing a manual partial transfer operation is shown, in accordance with one embodiment of the present invention. The flowcharts shown in FIGS. 7-9 together describe one embodiment for effectively utilizing the present invention. The FIG. 9 flowchart is presented for purposes of illustration, and in alternate embodiments, the present invention may utilize steps and sequences in addition to, or instead of, certain of the steps and sequences discussed in conjunction with the FIG. 9 embodiment.

In the FIG. 9 embodiment, in step 912, controller logic 212 copies the internal rectangle coordinates 428 that define the current transfer rectangle to external rectangle coordinates 432 which may then be accessed and utilized by external entities such as CPU 122 (FIG. 1). In step 916, controller logic 212 resets the internal rectangle coordinates 428, write counter 228, and transfer timer 232 to initialized values. Step 712 of FIG. 7 and step 812 of FIG. 8 may then begin through connecting letter “A”.

In addition, in step 920, controller logic 920 generates a transfer interrupt to CPU 122 to indicate that a transfer trigger event from either write counter 228 or transfer timer 232 has occurred. In response, in step 924, CPU 122 coordinates a partial transfer of the current transfer rectangle represented by external rectangle coordinates 432 to display 134 (FIG. 1). In certain embodiments, CPU 122 may periodically poll external rectangle coordinates 432 to determine whether a partial transfer operation is required, instead of controller logic 212 affirmatively sending the foregoing transfer interrupt as a notification to CPU 122. For at least the foregoing reasons, the present invention therefore provides an improved system and method for efficiently performing manual partial transfers of image data.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A system for handling electronic information, comprising:
a rectangle module that detects write operations to on-screen data in a video memory, said rectangle module continually updating a transfer rectangle to include written data from said write operations;
controller logic that generates a transfer interrupt in response to a transfer trigger event for initiating a manual partial transfer operation from said video memory to a data destination; and
a central processing unit that coordinates said manual partial transfer operation in response to said transfer interrupt to thereby transfer rectangle data of said transfer rectangle from said video memory to said data destination.

2. The system of claim 1 wherein said controller logic and said rectangle module are implemented in a display controller that performs said manual partial transfer operation under direction of said central processing unit.

3. The system of claim 2 wherein said display controller conserves device resources and operating power for a portable electronic device by transferring only said transfer rectangle, said display controller being implemented as an integrated circuit device that functions as a transparent interface between said central processing unit and a display of said portable electronic device.

4. The system of claim 1 wherein said data destination includes a display for a portable electronic device, said display being implemented as a random-access-memory based liquid-crystal display.

5. The system of claim 4 wherein said portable electronic device is implemented as a portable cellular telephone device.

6. The system of claim 1 wherein utilizing said transfer rectangle for performing a partial transfer of only said rectangle data from said transfer rectangle conserves system resources and operating power for a portable host electronic device because said partial transfer operates on a reduced amount of said on-screen data as compared to transferring entire frames of said on-screen data from said video memory.

7. The system of claim 1 wherein said controller logic generates said transfer interrupt in response to said transfer trigger event that alternately includes a transfer timer trigger that occurs after a pre-determined transfer period has been exceeded, and a write counter trigger that indicates that a total written pixel value has exceeded a pre-determined write-operation pixel threshold.

8. The system of claim 1 wherein said rectangle module updates a current version of said transfer rectangle to produce an updated version of said transfer rectangle whenever said written data from said write operations is located outside of said current version of said transfer rectangle.

9. The system of claim 1 wherein said transfer rectangle is defined by a rectangle notation:
[(x₁, y₁), (x₂, y₂)]
where said (x₁, y₁) are pixel coordinates of a top left pixel from said transfer rectangle, and where said (x₂, y₂) are bottom right coordinates of said transfer rectangle.

10. The system of claim 9 wherein said rectangle module detects that a new pixel (X, Y) has been written into said on-screen data, said rectangle module responsively performing four tests for updating said transfer rectangle, said rectangle module determining whether said X is less than said x₁, and if so, then updating said x₁ to equal said X, said rectangle module also determining whether said X is greater than said x₂, and if so, then updating said x₂ to equal said X, said rectangle module further determining whether said Y is less than said y₁, and if so, then updating said y₁ to equal said Y, said rectangle module additionally determining whether said Y is greater than said y₂, and if so, then updating said y₂ to equal said Y.

11. The system of claim 1 wherein said controller logic increments a write counter whenever one of said write operations to said on-screen data occurs.

12. The system of claim 11 wherein said controller logic determines that a current counter value of said write counter is greater than a pre-determined counter threshold value, said controller logic then responsively generating said transfer interrupt.

13. The system of claim 1 wherein said controller logic runs a transfer timer to measure a pre-determined transfer period, said controller logic generating said transfer interrupt when said pre-determined transfer period has elapsed.

14. The system of claim 13 wherein said controller logic generates said transfer interrupt when said pre-determined transfer period has elapsed and at least one of said write operations to said on-screen data has occurred.

15. The system of claim 1 wherein said controller logic copies internal rectangle coordinates that define said transfer rectangle to external rectangle coordinates which are accessible by said central processing unit for performing said manual partial transfer operation.

16. The system of claim 15 wherein said controller logic resets said internal rectangle coordinates, a write counter, and a transfer timer to respective initialized values for beginning a subsequent manual partial transfer operation.

17. The system of claim 16 wherein said controller logic generates said transfer interrupt to indicate that said transfer trigger event from either said write counter or said transfer timer has occurred.

18. The system of claim 17 wherein said controller logic actively sends said transfer interrupt to said central processing unit as a notification of said transfer trigger event.

19. The system of claim 17 wherein said central processing unit periodically polls said controller logic to determine whether said transfer interrupt has been generated.

20. The system of claim 17 wherein said central processing unit instructs said controller logic to transfer said rectangle data to display logic of said data destination, said display logic responsively writing said rectangle data into a specific local storage location, said display logic then providing said rectangle data from said specific local storage location to a screen of said data destination for displaying to a device user.

21. A method for handling electronic information, comprising the steps of:
detecting write operations to on-screen data in a video memory by utilizing a rectangle module that continually updates a transfer rectangle to include written data from said write operations;
generating a transfer interrupt with controller logic in response to a transfer trigger event for initiating a manual partial transfer operation from said video memory to a data destination; and
coordinating said manual partial transfer operation with a central processing unit in response to said transfer interrupt to thereby transfer rectangle data of said transfer rectangle from said video memory to said data destination.

22. The method of claim 21 wherein said controller logic and said rectangle module are implemented in a display controller that performs said manual partial transfer operation under direction of said central processing unit.

23. The method of claim 22 wherein said display controller conserves device resources and operating power for a portable electronic device by transferring only said transfer rectangle, said display controller being implemented as an integrated circuit device that functions as a transparent interface between said central processing unit and a display of said portable electronic device.

24. The method of claim 21 wherein said data destination includes a display for a portable electronic device, said display being implemented as a random-access-memory based liquid-crystal display.

25. The method of claim 24 wherein said portable electronic device is implemented as a portable cellular telephone device.

26. The method of claim 21 wherein utilizing said transfer rectangle for performing a partial transfer of only said rectangle data from said transfer rectangle conserves system resources and operating power for a portable host electronic device because said partial transfer operates on a reduced amount of said on-screen data as compared to transferring entire frames of said on-screen data from said video memory.

27. The method of claim 21 wherein said controller logic generates said transfer interrupt in response to said transfer trigger event that alternately includes a transfer timer trigger that occurs after a pre-determined transfer period has been exceeded, and a write counter trigger that indicates that a total written pixel value has exceeded a pre-determined write-operation pixel threshold.

28. The method of claim 21 wherein said rectangle module updates a current version of said transfer rectangle to produce an updated version of said transfer rectangle whenever said written data from said write operations is located outside of said current version of said transfer rectangle.

29. The method of claim 21 wherein said transfer rectangle is defined by a rectangle notation:
[(x₁, y₁), (x₂, y₂)]
where said (x₁, y₁) are pixel coordinates of a top left pixel from said transfer rectangle, and where said (x₂, y₂) are bottom right coordinates of said transfer rectangle.

30. The method of claim 29 wherein said rectangle module detects that a new pixel (X, Y) has been written into said on-screen data, said rectangle module responsively performing four tests for updating said transfer rectangle, said rectangle module determining whether said X is less than said x₁, and if so, then updating said x₁ to equal said X, said rectangle module also determining whether said X is greater than said x₂, and if so, then updating said x₂ to equal said X, said rectangle module further determining whether said Y is less than said y₁, and if so, then updating said y₁ to equal said Y, said rectangle module additionally determining whether said Y is greater than said y₂, and if so, then updating said y₂ to equal said Y.

31. The method of claim 21 wherein said controller logic increments a write counter whenever one of said write operations to said on-screen data occurs.

32. The method of claim 31 wherein said controller logic determines that a current counter value of said write counter is greater than a pre-determined counter threshold value, said controller logic then responsively generating said transfer interrupt.

33. The method of claim 21 wherein said controller logic runs a transfer timer to measure a pre-determined transfer period, said controller logic generating said transfer interrupt when said pre-determined transfer period has elapsed.

34. The method of claim 33 wherein said controller logic generates said transfer interrupt when said pre-determined transfer period has elapsed and at least one of said write operations to said on-screen data has occurred.

35. The method of claim 21 wherein said controller logic copies internal rectangle coordinates that define said transfer rectangle to external rectangle coordinates which are accessible by said central processing unit for performing said manual partial transfer operation.

36. The method of claim 35 wherein said controller logic resets said internal rectangle coordinates, a write counter, and a transfer timer to respective initialized values for beginning a subsequent manual partial transfer operation.

37. The method of claim 36 wherein said controller logic generates said transfer interrupt to indicate that said transfer trigger event from either said write counter or said transfer timer has occurred.

38. The method of claim 37 wherein said controller logic actively sends said transfer interrupt to said central processing unit as a notification of said transfer trigger event.

39. The method of claim 37 wherein said central processing unit periodically polls said controller logic to determine whether said transfer interrupt has been generated.

40. The method of claim 37 wherein said central processing unit instructs said controller logic to transfer said rectangle data to display logic of said data destination, said display logic responsively writing said rectangle data into a specific local storage location, said display logic then providing said rectangle data from said specific local storage location to a screen of said data destination for displaying to a device user.

41. A system for handling electronic information, comprising:
means for detecting write operations to on-screen data in a video memory, said means for detecting continually updating a transfer rectangle to include written data from said write operations;
means for generating a transfer interrupt in response to a transfer trigger event for initiating a manual partial transfer operation from said video memory to a data destination; and
means for coordinating said manual partial transfer operation in response to said transfer interrupt to thereby transfer rectangle data of said transfer rectangle from said video memory to said data destination.

42. A system for handling electronic information, comprising:
a rectangle module that updates a transfer rectangle to include written data from write operations to a memory device; and
controller logic that generates a transfer interrupt in response to a transfer trigger event for initiating a manual partial transfer operation of said transfer rectangle to a data destination.
